(19) United States
(12) Patent Application Publication
(10) Pub. No.: US 2008/0306948 A1
(43) Pub. Date: Dec. 11, 2008

(54) STRING AND BINARY DATA SORTING

(75) Inventors: RadhaKrishna Uppala, Bellevue, WA (US); Sreenivasulu Pokuri, Bellevue, WA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/760,523

(22) Filed: Jun. 8, 2007

(51) Int. Cl. G06F 17/30

(52) U.S. Cl. 707/7; 707/E17.105

(57) ABSTRACT

A device, system, and method are directed towards sorting a set of string or binary data items. A segment of a fixed size from each data item is combined with a pointer to the data item in a word. The words are sorted, and words having equivalent string/binary segments are grouped together. The groups are recursively sorted until no groups remain or the end of the string or binary data in a group is sorted. Methods of the invention include determining a segment size based on a size of a pointer item and a word size, so that a segment and a pointer fit within a word, allowing comparisons and data manipulation to be performed on words.

### FIELD OF THE INVENTION

The present invention relates generally to manipulation of data and, more particularly, but not exclusively to sorting string or binary data in a database or other data structure.

### BACKGROUND OF THE INVENTION

Sorting may be considered to be a process of arranging items in an ordering or a sequence. Items can be sorted based on one or more fields, and a variety of orderings may be used, including lexicographical, numerical, logical, variations or combinations thereof, or other types of ordering. Items may include text or binary fields. Sorting of items may be useful in a variety of systems. The maintenance of items in an ordered manner to facilitate retrieval is one example of a use of sorting.

Quicksort is one example of a sorting algorithm. Quicksort has been described as sorting by employing a strategy to divide a list into two sub-lists, using a series of steps including: picking a list item, called a pivot, from the list; reordering the list so that all items that are less than the pivot come before the pivot and items that are greater than the pivot come after it recursively sorting the sub-list before the pivot and after the pivot.

A CPU cache is a block of memory that is used to temporarily store and access data that is likely to be used again. A CPU cache is a block of fast memory that is used by a CPU to access data. Typically, access to data in a CPU cache is faster than access to data in a computer's main memory or other data storage.

Generally, it is desirable to employ efficient sorting techniques for ordering and maintaining data items. Efficient in this context may mean an improvement in time, processing time, memory, or other resources. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 shows one embodiment of a computing device that may be employed in a system implementing the invention;

FIGS. 2-6 are block diagrams generally showing an example sequence of data structures that may be used in one embodiment of a process for sorting data items; and

FIG. 7 is a logical flow diagram generally showing one embodiment of a process for sorting data items.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” an item, such as a request, response, or other message, from a device or component includes receiving the message indirectly, such as when forwarded by one or more other devices or components. Similarly, “sending” an item to a device or component includes sending the item indirectly, such as when forwarded by one or more other devices or components.

As used herein, the term “string” or “string data” refers to an ordered sequence of symbols or binary data. Strings may include a string of text, binary data, or a combination thereof. String data has a length that may be measured in terms of bits or bytes. The term “string/binary data” as used herein has the same meaning, and is interchangeable with “string” or “string data.”

As used herein, the term “word” refers to a fixed-size group of bits that are handled together by a processor. A processor has an associated word size, which refers to the number of bits in a word handled by the processor. For example, typical processors may have associated word sizes of 16, 32, or 64 bits. As processors evolve, more advanced processors typically have larger word sizes. In many of the examples described herein, a word size of 64 bits is used. The invention is not so limited, however, and the present invention may be employed with virtually any word size, including processors that may use variable word sizes. In one embodiment, a desired word size may be determined by a capacity of a bus or other component instead of, or in addition to, a processor.

Briefly stated, the present invention is directed toward a mechanism for sorting a set of string data items. Methods of the invention may include extracting, from each data item, a fixed length substring, creating an array of the substrings and pointers to the original strings, sorting the substrings, determining groups of equivalent substrings, and recursively sorting each group. Methods of the invention may include determining the fixed length based on a word size of a processor employed to perform instructions for sorting. Methods of the invention may further include determining the fixed length based on a length desired for the pointers to the original strings.

Systems and methods of the invention may include extracting a segment of each original string beginning at an offset of zero within the string, storing each extracted segment in a corresponding word, and combining a reference pointer to the original string with the corresponding segment in the word to produce a working set of data items. The working set of data items may then be sorted using any one or more of a variety of sorting techniques. Actions may further include comparing the data items of the working set to determine whether one or more equivalence groups exist, such that each equivalence group includes equivalent data items. Equivalent as used herein may be determined by comparing the extracted string/binary data, apart from the reference pointers. Strings may be considered to be equivalent even if they differ. For example, upper and lower case letters may be considered to be equivalent, some punctuation may be ignored, and the like. Actions may further include, for each equivalence group, recursively extracting additional segments, sorting, and determining equivalence groups.

Systems and methods of the invention may include determining a length of the extracted segments to use based on the word size associated with a processor, and based on a size of the reference pointer. At each level of recursion, the offset may be incremented by the determined length. Sorting a working set may be performed by sorting an array of words, wherein each word contains an extracted segment in the high order bits and a reference pointer in the low order bits.

Systems and methods of the invention may include not sorting data items after it is determined that they are not part of an equivalence group.

### Illustrative Operating Environment

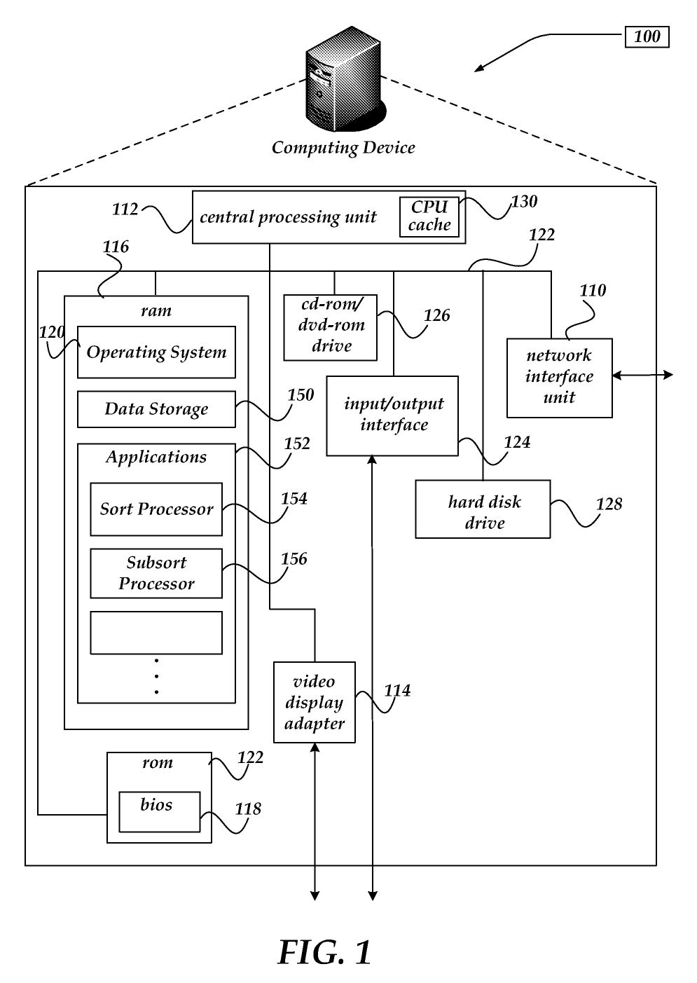

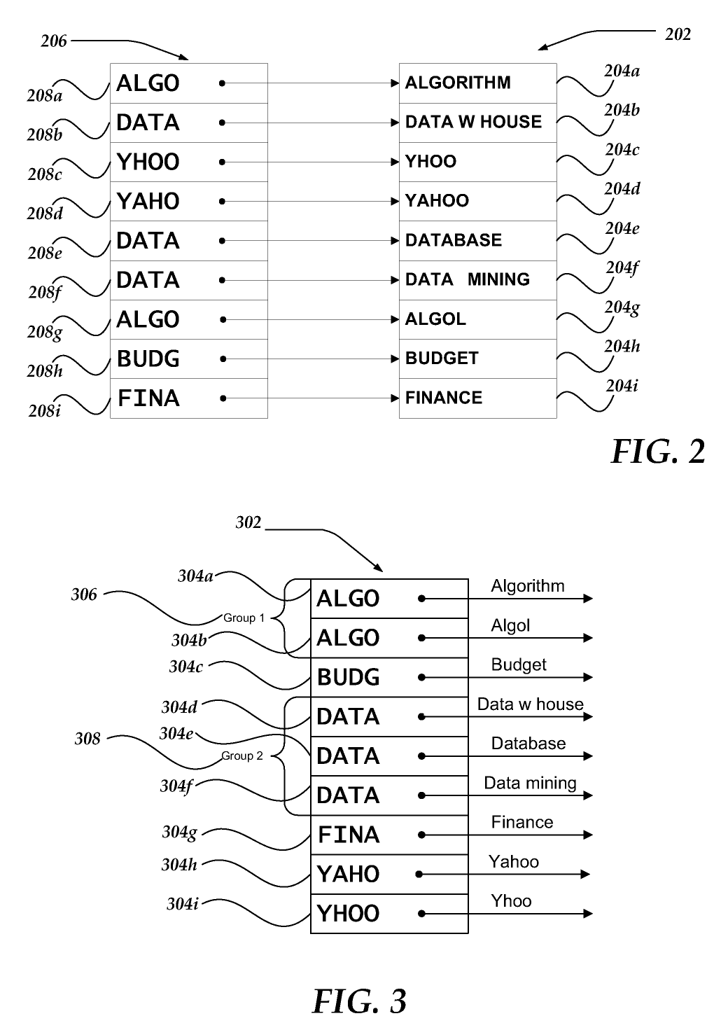

FIG. 1 shows one embodiment of a computing device 100, according to one embodiment of the invention. The embodiment of computing device 100 illustrated in FIG. 1 may be used to implement all, or a portion of, methods of the present invention and associated processes. Computing device 100 may include many more components than those shown. It may also have less than all of those shown. The components shown, however, are sufficient to disclose an illustrative embodiment for practicing the invention. One or more computing devices, and the application programs integrated with the devices, may be used to implement various embodiments of processes of the present invention, as illustrated in FIGS. 2-7 and discussed herein.

Computing device 100 includes central processing unit (CPU) 112 (also referred to as a processor), video display adapter 114, and a mass memory, all in communication with each other via bus 122. Central processing unit 112 includes a CPU cache memory 130. Cache memory 130 may be used to cache program instructions or data for use by the central processing unit 112. The mass memory generally includes RAM 116, ROM 122, and one or more permanent mass storage devices, such as hard disk drive 128, tape drive, optical drive, and/or floppy disk drive. The mass memory stores operating system 120 for controlling the operation of computing device 100. Any general-purpose operating system may be employed. Basic input/output system (“BIOS”) 118 is also provided for controlling the low-level operation of computing device 100. As illustrated in FIG. 1, computing device 100 also can communicate with the Internet, or some other communications network, via network interface unit 110, which is constructed for use with various communication protocols including the TCP/IP protocol. Network interface unit 110 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more data storage components 150 may include program code or data used by the operating system 120 or by applications 152. Data may be stored in ram 116 or other storage devices, such as hard disk drive 128. One or more applications 152 and application components are loaded into mass memory and run on operating system 120. Examples of application programs may include search programs, transcoders, schedulers, calendars, database programs, word processing programs, HTTP programs, customizable user interface programs, IPSec applications, encryption programs, security programs, VPN programs, SMS message servers, IM message servers, email servers, account management and so forth.

In one embodiment, applications 152 may include a sort processor 154. A sort processor may include program logic that performs actions relating to performing all or a portion of the actions of sorting a set of string data items in accordance with the present invention.

In one embodiment, applications 152 may include a subsort processor 156. A subsort processor may include program logic that performs actions for sorting a subset of strings. The subsort processor 156 may be employed to perform a portion of the actions of sorting strings within the methods of the present invention. One or more subsort processors may be used with the present invention.

In one embodiment, computing device 100 may be a server in communication with one or more client computing devices or other servers. In one embodiment, computing device 100 may be a client device.

Communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

### Generalized Operation

FIGS. 2-6 are illustrations of a set of data items that are sorted, as well as intermediate elements. As illustrated in FIG. 2, an original set of data items 202 includes a number of data items 204a-i. Each data item 204a-i includes a corresponding string. The illustrated strings are “ALGORITHM”, “DATA W HOUSE”, “YHOO”, “YAHOO”, and so forth. It is to be noted that the illustrated strings have differing lengths.

In one embodiment, the set of data items 202 may be an array of data items or an array of pointers or indices to data items. Various other data structures may be used to represent the set of data items. In one embodiment, each data item may have additional corresponding data. For example, the data item may be part of a database record having one or more additional fields, or a link to additional fields or data. To keep the illustration simple, additional fields are not shown.

FIG. 2 illustrates a working set of elements 206 that may be used in accordance with the present invention. In one embodiment, the working set of elements 206 may be created such that each element is a fixed size, and in particular, the fixed size may be the word size corresponding to the CPU of a computing device such as CPU 112 of FIG. 1. In one embodiment, a word size of 64 bits is used, though the invention is not so limited.

The working set of elements 206 includes elements 208a-i, wherein each element 208a-i has a corresponding data item 204a-i of the original set of data items 202. As illustrated in FIG. 2, each element 208a-i has a fixed length, and is divided into two fields. A first field contains string or binary data extracted from the corresponding original data items 204a-i. A second field contains a pointer, index, offset, or other type of data that references the corresponding original data item 204a-i. As used herein, the term pointer is used to include any type of data that may be used to reference or locate an original data item 204a-i. In FIG. 2, each element 208a-i has an arrow illustrating the correspondence between the pointer and the corresponding original data item 204a-i.

In one embodiment of the invention, each of the elements 208a-i is divided into two fields in the following way. A determination is made of a size needed or desired to contain a pointer to the original data item. The determined size is used as the size of the pointer field. In one embodiment the pointer size may be rounded up so that it corresponds to a whole number of bytes. This size is then subtracted from the word size to determine the size of the string/binary field. For example, in an embodiment having a word size of 64 bits, a pointer of 32 bits may be determined. This leaves 32 bits for the string/binary field. In another example, a pointer may be 24 bytes, leaving 40 bits for the string/binary field in a 64-bit field. In yet another example, a word size of 32 bits may be used with a pointer size of 16 bits and a string/binary field size of 16 bits. Various other word, pointer, and string/binary field sizes may be used. In one embodiment, an element 208a-i may be sized to include two or more words. For example, in an architecture having a 32-bit word size, an element size of 64 bits may be used. In one embodiment, the high order bits of an element contain the string/binary field and the low order bits contain the pointer field. For example, in an architecture having a 64-bit word size, the high order 32 bits may be used for the string/binary field and the low order 32 bits may be used for the pointer field.

In one embodiment, the string/binary field of each element 208a-i is filled by extracting a segment from the beginning of the corresponding original data item 204a-i, the segment having a length equal to a number of bits corresponding to the field size. In FIG. 2, each original data item 204a-i contains a text string, and each character of the string is 8 bits long. In other embodiments, a character may be 16 bits, 24 bits, or another size. As illustrated, in the first element 208a, the characters “ALGO” have been extracted from the string “ALGORITHM” in the corresponding original data item 204a. Similarly, the first 4 characters from each original data item 204b-i have been extracted and stored in each corresponding element 208b-i. In one embodiment, if the extracted characters do not fill the string/binary field of the element 208a-i, the field is padded with nulls, or bits of zero, at the end.

After filling the elements 208a-i, the working set of elements 206 may be sorted. In one embodiment, subsort processor 156 may be employed to perform all or a portion of this sort. A conventional sorting technique, such as Quicksort, may be used to perform all or a portion of this sorting. A combination of sorting techniques may also be used. Sorting the elements may include performing comparisons of various elements to determine an ordering. In one embodiment, sorting is performed so that comparisons are performed on the entire word containing each element. For example, the element 208a, including “ALGO” and the corresponding pointer, may be compared with element 208b, including “DATA” and the corresponding pointer. Generally, comparing the entire word may be performed faster than extracting the string/binary field from each and comparing them. During the sorting, the contents of one or more elements may be moved to a different element. In one embodiment, moving the contents of an element is performed by moving an entire word.

FIG. 3 illustrates a working set of elements 302, having elements 304a-i, as it may appear after a first round of sorting, as described above. The working set of elements 302 may be the same physical set of elements 206 of FIG. 2, or it may be a new set in which the contents of the set of elements 206 have been copied. For simplicity of discussion, each set is referred to distinctly, though this does not imply either alternative implementation, and either one or a combination thereof may be used unless clearly stated otherwise. For illustrative purposes, the text of the original string corresponding to each element is provided above each arrow representing the pointer to the original data item.

As shown in FIG. 3, the contents of at least some of the elements have been moved. The rearrangement reflects a sorting based on the string/binary fields extracted from the original data items 204a-i as discussed above. In one embodiment, sorting is performed on an entire word, and the pointer field in each element may be included in the comparison operations. Inclusion of the pointer field may cause the sorting method to be stable. That is, when the string/binary fields of two or more elements are equivalent, their relative order is maintained following a comparison. If two or more elements are equivalent, their relative order will therefore be maintained by the methods of the present invention.

As shown in FIG. 3, the elements 304a-i have string/binary fields that are ordered in lexicographical order. In various embodiments, variations on lexicographical order may be used to order the fields, or other types of orderings may be used. Also, fields may be ordered in ascending or descending order. To simplify discussion, reference numbers for elements 304a-i are provided to be consistent with reference numbers 208a-i in FIG. 2 with respect to position, rather than the content. For example, reference numbers 208b and 306b refer to the second element in FIGS. 2 and 3, respectively, regardless of movement of the element or the element contents during performance of the method described herein. Thus, as can be seen by the arrow label “Algol”, element 304b corresponds to and points to the original string/binary data item 204g. Reference numbers in FIGS. 4-6 are similarly used.

Methods of the present invention may include performing comparisons to determine groups of elements that have equivalent elements. These groups are referred to herein as “equivalence groups,” or simply “groups.” In one embodiment, a determination of equivalent elements may ignore the reference pointer field, such that differences in this field are not significant. In the example illustration of FIG. 3, a first group, “Group 1” 306 includes elements 304a and 304b, each having an equivalent string/binary field containing “ALGO”. A second group, “Group 2” 308, includes elements 304d, 304e, and 304f, each having an equivalent string/binary field containing “DATA”. It is to be noted that in some embodiments, equivalent fields may include string/binary data that is not identical. For example, if case of characters is not considered, upper and lower case letters may be considered to be equivalent, though not identical. In other examples, selected punctuation, blanks, white space, articles or prepositions, leading zeros, or the like may be ignored during a comparison, such that different strings are considered to be equivalent.

In FIG. 3, each of elements 304c (“Budget”), 304g (“Finance”), 304h (“Yahoo”), and 3041 (“Yhoo”) do not have equivalent elements and therefore are not within a group. It is to be noted that each of these elements is in the final position it will be in upon conclusion of the sorting method. In one embodiment, the relative position of these elements will not be changed during the remainder of the process discussed herein.

FIG. 4 illustrates a working set of elements 402 having elements 404a-i, corresponding to the working set of elements 302 and elements 304a-i of FIG. 3. As discussed above, the working set of elements 402 may be the physically the same as the working set of elements 302, or a copy thereof.

In FIG. 4, group 1 (406) includes elements 404a and 404b. Group 1 (406) of FIG. 4 corresponds to group 1 (306) of FIG. 3. The content of the string/binary fields of elements 404a and 404b have been created in a manner similar to the creation of the fields in the working set of elements 206 of FIG. 2. In one embodiment, this includes extracting segments from the original strings of the original set of data items 202. Unlike the extraction discussed above with reference to FIG. 2, the present extraction of data begins at a non-zero offset. In the illustrated example, the offset used is 4 characters, or 32 bits. This is based on the size of the string/binary field in each element as discussed above. Thus, the four characters “RITH” are extracted from data item 204a at offset 4 and stored in element 404a. Since data item 204g has only one remaining character, “L”, this character is extracted and padded with three null bytes, or 24 zero bits. It is to be noted that because the element corresponding to the original data item 204g (“ALGOL”) has been moved, element 404b corresponds to original data item 204g.

Upon filling the string/binary fields of each element of the group, the group is sorted, in a manner as discussed above with respect to sorting the working set of elements 206. The same technique as used for the first sort may be used, a variation of the technique may be used, or a different sort technique may be used. In one embodiment, a determination of a technique to employ for sorting each group may be based on the number of elements within each group.

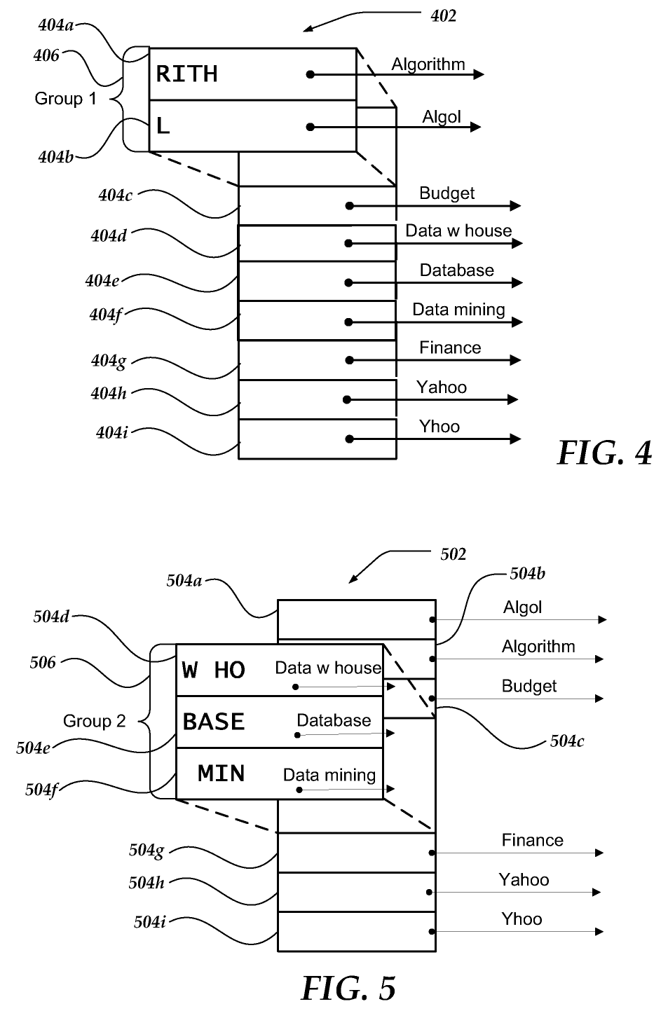

In one embodiment, at least some of the actions of extracting data from the original set of data items and sorting elements within a group are performed by recursively performing the operations as discussed above. Similar procedures may be followed for each identified group. FIG. 5 illustrates a working set of elements 502 having elements 504a-i. Elements 504a and 504b have been swapped as a result of the sorting discussed above. Group 2 (506) containing elements 504d, 504e, and 504f contain string/binary data resulting from extracting data from the original strings “DATA W HOUSE”, “DATABASE”, and “DATA MINING” from the original data items 204b, 204e, and 204f, respectively, at an offset of 4. The elements of group 2 (506) may then be sorted as discussed above for group 1 (406).

Processes of the invention may recursively perform similar actions on each identified group, including extracting data at a specified offset. During the recursive processes, additional groups may be identified and recursively sorted, until no groups remain and all elements are properly sorted.

In one embodiment, during each recursive operation on an equivalence group the set of elements in the equivalence group may be considered to be a target set of elements corresponding to a target set of string/binary data items of the original set of data items. The designation of target set, which applies to both the equivalence group and the corresponding data items of the original set of data items, may be used to refer to the appropriate elements for an instance of recursion. Therefore, the designation of target set is one that may change with each recursive set of actions. The term target set may also be used similarly in non-recursive implementations.

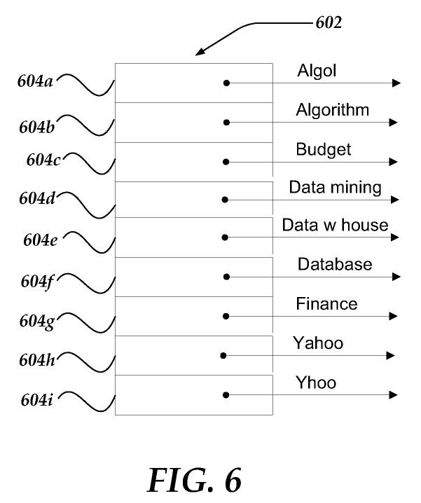

FIG. 6 illustrates a working set of elements 602 having elements 604a-i after completion of a sorting process in accordance with one embodiment of the invention. Each element includes a corresponding string/binary field. The illustrated strings are “ALGOL”, “ALGORITHM”, “BUDGET”, “DATA MINING”, and so forth. In the illustrated example, the strings are in an ascending lexicographical order. As discussed above, different orderings may be used with the present invention. The pointers within each element 604a-i may be used to rearrange the original data items 204a-i of FIG. 2, generate an ordered copy of the set of original data items 202, or in another manner.

In one embodiment, processes of the present invention improve the efficiency of subsorts, such as Quicksort, that may be used. This may occur by using the subsort on fixed length string/binary data. Improved efficiency may occur due to having sort fields that fit within a word length, such that comparisons may be performed on single words. Improved efficiency may occur due to combining a string/binary data field with a pointer in each word, so that moving elements during a sorting subprocess can be performed by moving a single word. Improved efficiency may occur due to having a set of elements that require less memory. A reduction in memory may result in a greater portion of processing being performed by referencing CPU cache memory. CPU cache memory provides faster access times than typical RAM.

It is to be noted that, in one embodiment, each iteration of a subsort may result in one or more elements that are not part of a group, and are in a position that does not require changing during the remainder of the process. For example, in FIG. 3, the elements 304c (“BUDGET”), 304g (“FINANCE”), 304h (“YAHOO”) and 3041 (“YHOO”) are in positions that are in their correct final position relative to other elements, and therefore do not need to be compared or sorted during the remainder of the process. Thus, each iteration of the process may identify elements that require additional sorting and elements that do not require additional sorting. The term “requires additional sorting” refers to the aspect that the elements are not known to be in their correct position, rather than to any possibly correct ordering that may be discovered through subsequent comparison, analysis or computation.

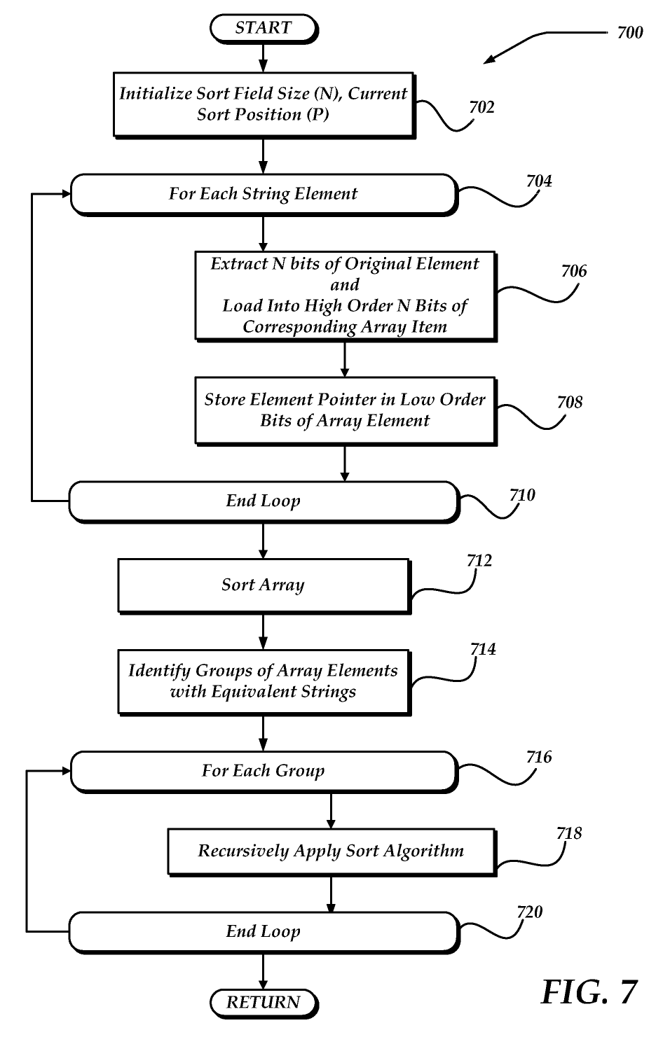

FIG. 7 is a logical flow diagram generally showing one embodiment of a process 700 for sorting a set of data items. Process 700 may employ at least a portion of the computing device 100 illustrated in FIG. 1, including sort processor 152 or subsort processor 156, or any of the device variations as discussed herein, or it may be performed with other devices. In one embodiment, all, or at least a portion of the actions of process 700 may be combined with any one or more of the actions discussed above or illustrated in FIGS. 2-5.

Process 700 begins, after a start block, at block 702, where initialization is performed. In one embodiment, initialization includes determining a sort field size (N). The sort field size corresponds to the length of the string/binary field employed in elements 208a-i of FIG. 2, and corresponding elements in FIGS. 3-5. In one embodiment, the sort field size is based on the word size of the computer architecture, and in particular, the CPU word size. In one embodiment, the sort field size is based on a size of a pointer field, and, in particular, the size of a pointer used to reference the original data items to be sorted. In one embodiment, the sort field size is determined by subtracting the pointer size from the word size. As discussed above, in one embodiment, having a 64-bit CPU, a pointer size of 32 bits is used together with a sort field size of 32 bits.

In one embodiment, initialization 702 may include setting a current sort field position (P) variable to zero. The current sort field position represents the offset from the beginning of each original string/binary data item that is currently being used in the current sort iteration. In subsequent iterations, the current sort field position value may be incremented by an amount corresponding to the sort field size, or by an amount representative of the iteration in order to determine a sort field offset.

After initialization, process may then flow to block 704. At block 704, the process may begin a loop of actions. The loop beginning at block 704 may be performed for each data item of the set of data items to be sorted. The loop beginning at block 704 may include at least some of the actions of blocks 706 and 708, which are now discussed.

At block 706, a segment having length N bits (the sort field size) is extracted from the original string/binary data item, beginning at the offset indicated by the current sort position (P). This segment of data may be stored in the high order N bits of the string/binary field of the corresponding element, such as elements 208a-i of FIG. 2. The working set of elements 206 of FIG. 2 may be referred to as an array of elements, and the elements may be referred to as array elements. During an initial performance of actions of process 700, the entire original set of data items may be considered to be a target set, and the corresponding elements may be considered a corresponding target set of elements. During subsequent, or recursive actions, the target set may be the elements of an equivalence group or the corresponding string/binary data items of the original set of data items.

The original string/binary data items may have data of different lengths. In one embodiment, at block 706, when extracting string/binary data, if the end of the data has been reached, nulls or other minimal values may be used to fill the string/binary field of the element. For some data items, this may result in an entire string/binary field being filled with null values.

Process flow may then proceed to block 708, where a data item pointer is stored in the low order bits of the element. The data item pointer is a pointer, index, or other type of data that references the corresponding original data item. In one embodiment, the action of block 708 is performed on the first level of recursion of the process 700, and is not performed on subsequent recursive iterations.

Process flow may then proceed to block 710, which ends the loop begun at block 704. If the looping is not complete, process may then flow back to block 704, to perform another iteration of the loop. If the looping is complete, process may then flow to block 712.

At block 712, the array elements may be sorted. A conventional sort technique, such as Quicksort, may be used to perform all or a portion of this sorting. As discussed above with reference to FIG. 2, sorting may be performed so that comparisons are performed on the entire word containing each element, including the pointer in the low order bits.

Process flow may then proceed to block 714, where one or more equivalence groups of array elements having equivalent string/binary fields may be identified. It may be possible that there are no such groups, in which case the sorting process, or the level of recursion is complete. In one embodiment, an element is not included in an equivalence group if its string/binary field is all nulls. This would indicate that there is no more data to extract. Therefore, any equivalent items that are all nulls are already sorted to the maximum extent. It is to be noted that for any instance of recursion, further recursion may end because there are no equivalence groups.

Process flow may then proceed to block 716, where a loop of actions may begin. The loop beginning at block 716 may be performed for each equivalence group that is identified. The loop beginning at block 716 may include the actions of block 718. The loop beginning at block 716 may be performed zero times. That is, there may be no non-null groups remaining to be sorted, and the loop may not perform the action of block 718. In one embodiment, two or more iterations of the loop beginning at block 716 may be performed concurrently. For example, multiple threads executing on multiple cores may each perform actions of different iterations of this loop, or portions thereof.

At block 718, the sorting process may be performed recursively within the group of elements. When entering a new level of recursion, the current sort position (P) may be incremented by the sort field size, so that the next substring extracted immediately follows the one previously extracted for each data item. For example, if the sort field is 32 bits, or 4 bytes, the current sort position may be incremented by 32, or 4 to reflect this. In one embodiment, the sort position indicates the level of recursion, and the offset can be determined based on this value.

The recursive sorting may include all, or at least a portion of the actions 702-720 described herein. Recursion may occur to virtually any number of levels, as required by the number of data items, the similarity of data items, and the length of the string/binary data to be sorted. As discussed above, in one embodiment, the action of block 708 is only performed during the first level of recursion.

In one embodiment, an alternative to recursive sorting may be performed for one or more groups. For example, a determination may be made that for a small number of elements in a group, the group may be sorted by an alternate technique, such as extracting the entire remaining string/binary data and performing a conventional sort. In one embodiment, an implementation may perform similar actions in a manner that is not considered recursive, but follows similar logic.

Process may then flow to block 720, where the loop beginning at block 716 may be ended. Process then may return to the calling program.

It will be understood that each block of the flowchart illustrations of FIG. 7, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustrations may also be performed concurrently with other blocks or combinations of blocks, or even in a different sequence than illustrated without departing from the scope or spirit of the invention.

Accordingly, blocks of the flowchart illustrations support combinations of means for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended

What is claimed as new and desired to be protected by Letters Patent of the United States is:

1. A method of sorting a plurality of string/binary data items with a computer system having a processor, comprising:
a) setting the plurality of string/binary data items to be a target set of data items;
b) storing a segment of each data item of the target set of data items to a working set of elements, each segment having an offset position P in its respective target string/binary data item and having a length less than or equal to a length N;
c) sorting the elements of the working set corresponding to the target set of data items;
d) determining whether at least one equivalence group exists such that each equivalence group includes equivalent elements of the working set corresponding to the target set of data items; and
e) if at least one equivalence group exists, for each of at least one of the at least one equivalence group, setting the data items of the plurality of string/binary data items corresponding to the equivalence group elements to be the target set of data items, and repeating method elements b-d by employing an offset position P based on a depth of the equivalence group; and
wherein at least one equivalence group is determined to exist and steps a-d are repeated at least one time.

2. The method of claim 1, wherein repeating elements b-d is performed recursively, and the position P employed to store a segment is incremented at each increased level of recursion.

3. The method of claim 1, wherein repeating elements b-d is performed recursively, and the position P employed to store a segment is incremented by N at each increased level of recursion.

4. The method of claim 1, further comprising, after determining whether at least one equivalence group exists, not sorting elements that have been determined to not be in an equivalence group.

5. The method of claim 1, further comprising sorting elements corresponding to each of the plurality of string/binary data items a number of times, the number of times corresponding to each element based on its corresponding inclusion in an equivalence group.

6. The method of claim 1, wherein the length N is based on a word size corresponding to the processor.

7. The method of claim 1, wherein the length N is based on a word size corresponding to the processor and a length of a reference value field sufficient to reference each of the plurality of string/data items.

8. The method of claim 1, further comprising combining a reference value corresponding to each string/binary data item of the plurality of data items in a word with a respective element of the working set of elements, and wherein sorting the elements of the working set comprises sorting a set of words, each word containing a string and a reference value.

9. The method of claim 1, wherein sorting the elements of the working comprises comparing a plurality of words, each word including a string and a reference value corresponding to one of the plurality of string/binary data items, wherein the string is in the high order bits of the word.

10. The method of claim 1, wherein sorting the elements of the working set comprises sorting a set of word items, each word item comprising exactly one word corresponding to each data item of the working set of data items.

11. The method of claim 1, wherein the plurality of string/binary data items includes string/binary data items of differing lengths, at least some of the string/binary data items having lengths greater than a word size, and wherein segments of the string/binary data items beyond the length N are selectively compared.

12. A modulated data signal configured to include program instructions for performing the method of claim 1.

13. A system for sorting a plurality of string/binary data items, comprising:
a) a processor;
b) means for extracting a first segment of each string/binary data item;
c) means for performing an intermediate sort of the first segment corresponding to each string/binary data item; and
d) means for selectively extracting and sorting a second segment of each string/binary data item.

14. The system of claim 13, wherein the means for extracting combines each first segment with a corresponding reference pointer to a corresponding string/binary data item.

15. The system of claim 13, wherein the means for extracting combines each first segment with a corresponding reference pointer to a corresponding string/binary data item in a corresponding word, and wherein the means for performing an intermediate sort sorts said words.

16. The system of claim 13, wherein the length of each first segment is based on a word size and a size of a reference pointer to each string/binary data item.

17. A processor readable medium that includes data, wherein the execution of the data provides for sorting a set of string/binary data items by enabling actions, including:
a) extracting a segment of each string/binary data item of the set of string/binary data items;
b) for each segment, combining the segment with a reference pointer to a corresponding string/binary data item of the set of string/binary data items to produce an element within a word;
c) sorting the elements;
d) determining whether at least one equivalence group exists, each equivalence group comprising elements having equivalent segments; and
e) selectively repeating actions a-d based on whether an element corresponding to a string/binary data item of the set of string/binary data items is in an equivalence group.

18. The processor readable medium of claim 17, wherein the actions further comprise recursively performing actions a-e until a sort completion criteria is reached.

19. The processor readable medium of claim 17, wherein the action of extracting a segment of each string/binary data item is performed a selected number of times for each string/binary data item, the number of times based on a length of the string/binary data item and a number of times a corresponding element is included in an equivalence group.

20. A method of sorting a plurality of string/binary data items with a computer system having a processor, comprising:
a) storing a segment of each data item to a set of words, each segment having an offset position P in its respective string/binary data item and having a length less than or equal to a length N;
b) combining, with each word of the set of words, a pointer to a corresponding string/binary data item of the plurality of string/binary data items;
c) sorting the set of words;
d) determining whether at least one equivalence group exists such that each equivalence group includes equivalent segments of data; and
e) if at least one equivalence group exists, for each of at least one of the at least one equivalence group, extracting a second segment of each data item corresponding to the equivalence group elements, and combining, in respective words, each second segment with a pointer to a corresponding string/binary data item of the plurality of string/binary data items, and sorting the words containing each combination of second segments and pointers; and
wherein at least one equivalence group is determined to exist.
